(19) United States
(12) Patent Application Publication
(10) Pub. No.: US 2013/0187551 A1
(43) Pub. Date: Jul. 25, 2013

(54) Method and System for Driving LEDs from a Source of Rectified AC Voltage

(71) Applicants: Benedict C.K. CHOY, Sunnyvale, CA (US); Marc Tan, Sunnyvale, CA (US)

(72) Inventors: Benedict C.K. CHOY, Sunnyvale, CA (US); Marc Tan, Sunnyvale, CA (US)

(73) Assignee: Supertex, Inc., Sunnyvale, CA (US)

(21) Appl. No.: 13/555,993

(22) Filed: Jul. 23, 2012

Related U.S. Application Data
(60) Provisional application No. 61/510,622, filed on Jul. 22, 2011.

(51) Int. Cl. H05B 37/02

(52) U.S. Cl. CPC H05B 37/02
USPC 315/122

(57) ABSTRACT

The present inventions relate to a control circuit for controlling a plurality of serially connected groups of LEDs. A control unit is connected in parallel to each group of a plurality of serially connected groups of LEDs. Each LED group is connected to the adjacent group of LEDs. The control unit is connected to a group of LEDs. The control unit performs the functions of voltage regulating/current regulating/bypass for the associated group of LEDs. The control unit can act as a by-pass unit permitting current to flow through the control unit rather than through the associated group of LEDs.

### TECHNICAL FIELD

The present inventions relate to methods and a device for regulating power to a string of serially connected LEDs driven from a source of rectified AC voltage.

### BACKGROUND

LED based solid state lighting finds increasing favor in the market place over incandescent and fluorescent lighting for reasons such as very high lifetime and high efficiency. One of the simplest methods for powering LEDs from an AC source is direct connection of LEDs to rectified AC with a ballast resistor in series. Besides being simple the method offers low cost, high reliability and low electromagnetic interference (EMI).

Further, LED manufacturers have started making high voltage LED modules by connecting multiple LEDs in series on a common substrate. These higher voltage LED modules are particularly suited for direct connection to the AC line using a ballast resistor.

One major disadvantage of the ballast resistor drive is poor efficiency, as a significant portion of the input voltage is applied to the ballast resistor resulting in waste of power. Another disadvantage is poor power factor, brought about by distortion in the input current waveform as flow of input current is discontinuous. Yet another disadvantage is poor LED utilization due to the discontinuous nature of the current flow. For applications where low efficiency, low power factor, or poor LED utilization are not acceptable, better solutions are needed.

Referring to FIG. 1, a driver circuit consisting of a rectifier, an energy storage capacitor, and a linear current regulator can be used to drive LEDs with a constant current from an AC power supply. A drawback of this approach is the power dissipated in the current regulator, which varies with line and load voltage, resulting in inefficient operation. A further disadvantage is poor power factor as high current pulses are drawn from the AC source during peak charging of the energy storage capacitor. This capacitor is a further drawback of this circuit since it typically is a high voltage electrolytic type, which is bulky and subject to failures in high temperature environments.

Referring to FIG. 2, switching regulators employing inductors are efficient in converting AC voltage into DC current. Their downsides include complex design, relatively high printed circuit board area, EMI, expensive components, inductors, and electrolytic capacitors (bulky and the major contributor to system failure). To provide power factor correction (PFC) additional circuitry is needed. An input filter is needed to control noise injection into the AC power line. To provide compatibility with lamp dimmers, yet more circuitry is required.

An ideal LED driver circuit would consist of a small, low cost integrated circuit, driving a string of low cost, low to medium brightness LEDs or a portion thereof and requiring no inductors, no capacitors (especially electrolytic), no heat sink, and very few inexpensive components such as a full wave rectifier and resistors to configure the drive, while providing high efficiency, high power factor, dimmer compatibility, good line and load regulation, low line current harmonics, and low EMI.

The various inventions disclosed herein overcome the disadvantages of the prior art.

### SUMMARY

Accordingly, in the present inventions described here, as an example, a control unit is connected in parallel to each group, of a plurality of serially connected groups of LEDs. Each LED group has two ends, a first end and a second end. The first end of a group of LEDs is connected to the second end of an adjacent group of LEDs. The control unit has three terminals: a first terminal, a second terminal and a third terminal. The first terminal of the control unit is connected to the first end of a group of LEDs. The second terminal of the control unit is connected to the second end of the group of LEDs. The third terminal of the control unit is connected to the second end of an immediately adjacent group of LEDs.

The control unit is capable of carrying a current, hereafter referred to as bypass current, around the LED group associated with the control unit. The control unit acts as a short in a region where the bypass current is below a certain threshold level, acts as a constant current source in a region where the bypass current is equal to the threshold level, and acts as open circuit when a sufficiently negative voltage is applied to the third terminal of the control unit. When acting as a short circuit, the control unit imposes a small voltage across the associated LED group, thereby effectively shunting current around the associated LED group. The LED group and control unit when seen as a unit offers small incremental resistance to flow of current on account of the low incremental resistance of the control unit. When acting as a current source, the control unit carries a bypass current at the threshold level while supporting a voltage across the control unit and associated LED group which can be as high as the forward voltage of the associated LED group. With a voltage across the control unit and associated LED group less than the forward voltage of the LED group only the control unit carries current and current through the LED group is zero. With a voltage across the control unit and associated LED group equaling the forward voltage of the LED group both the control unit and the LED group carry current. The LED group and control unit when seen as a unit offer a level of incremental resistance which depends on the voltage across the control unit and associated LED group, offering very high incremental resistance when the voltage is lower than the forward voltage of the LED group and offering very low incremental resistance when the voltage equals the forward voltage of the LED group. When acting as an open circuit, the bypass current is essentially zero. In this particular mode the current in the associated LED group is nonzero and the voltage across the control unit and the LED group is equal to the forward voltage of the LED group. The LED group and control unit when seen as a unit offers small incremental resistance to the flow of current on account of the low incremental resistance of the conducting LED group.

The voltage across an LED group is applied to the third terminal of an adjacent LED group, the adjacent group being the group with the lower threshold current, so as to cause the control unit of the adjacent group to transition from acting as a current source into acting as an open circuit.

The controls units promote the flow of rectified line current over the near full width of the AC line half cycle by bypassing an increasing number of LED groups as the rectified line voltage falls, and conversely, by engaging an increasing number of LED groups as the rectified line voltage rises. The threshold current levels of the control units are arranged in a progression of values so that LED groups are engaged one by one at progressively higher rectified line current as the rectified line voltage rises and, conversely, are bypassed one by one at progressively lower rectified line current as the rectified line voltage decreases. By doing so, the rectified line current rises and falls step like as the rectified line voltage rises and falls, thereby producing near proportional line current to line voltage, and thus, high power factor operation.

A feature of the example method is the absence of a central controller which provides control over the plurality of control units. Instead, the control units are self actuating and self sequencing, that is, rely on signals originating at the associated LED group and from an immediately adjacent LED group for control of their functionality.

The present inventions relate to a control circuit for controlling a plurality of serially connected groups of LEDs. A control unit is connected in parallel to each group of a plurality of serially connected groups of LEDs. Each LED group has two ends, a first end and a second end. The first end of a group of LED is connected to the second end of an adjacent group of LEDs. The control unit has three terminals: a first terminal, a second terminal and a third terminal. The first terminal of the control unit is connected to the first end of a group of LEDs. The second terminal of the control unit is connected to the second end of the group of LEDs. The third terminal of the control unit is connected to the second end of an adjacent group of LEDs. The control unit performs the functions of voltage regulating/current regulating/bypass for the associated group of LEDs. When the third terminal is at ground or negative, the control unit acts as a by-pass unit permitting current to flow through the control unit rather than through the associated group of LEDs.

The present inventions allow the line current to follow the shape of the sinusoidal line voltage closely, thereby exhibiting excellent power factor and low harmonic distortion. Power factor increases with the number of LED stages employed and a power factor over 90% is well within reach.

The present inventions do not require the use of any control circuits in the control units rated for the full rectified line voltage, but instead, control devices rated only at the forward voltage of the LED groups involved. For example, a design rated for 230VAC operation with high line operation at 265VAC may require control devices with a voltage rating of 500V in prior art designs, whereas the present inventions limit the voltage rating of control devices to 50V, having much lower cost, when the design employs 7 LED groups and a ballast control unit 50H.

Furthermore, the present inventions employ a control unit design that is self actuating or sequencing, that is, it does not require additional circuits for control, sensing, timing or sequencing of LED group bypass action. It is therefore a much simpler and economical solution than presently available for driving LEDs from a rectified AC power source. It offers excellent power factor, high efficiency, high efficacy, low THD, and low harmonics.

The present invention are also compatible with leading edge and trailing edge phase dimmers.

### BRIEF DESCRIPTION OF THE DRAWINGS

FIG. 1 is a circuit diagram of one embodiment of the prior art for controlling the power to a plurality of serially connected LEDs.

FIG. 2 is a circuit diagram of another embodiment of the prior art for controlling the power to a plurality of serially connected LEDs.

FIG. 3 is a circuit diagram of one embodiment of the device of the present inventions.

FIG. 4 is a detailed circuit diagram of a control unit of the present inventions for use in the device of the present inventions, although the Source Rs resistors can be external from the integrated circuit, shown in FIG. 3.

FIG. 5 is a waveform diagram of the AC line voltage and line current of an exemplary embodiment of the present inventions.

FIG. 6 is a waveform diagram of the rectified line voltage and the rectified line current of an exemplary embodiment of the present inventions.

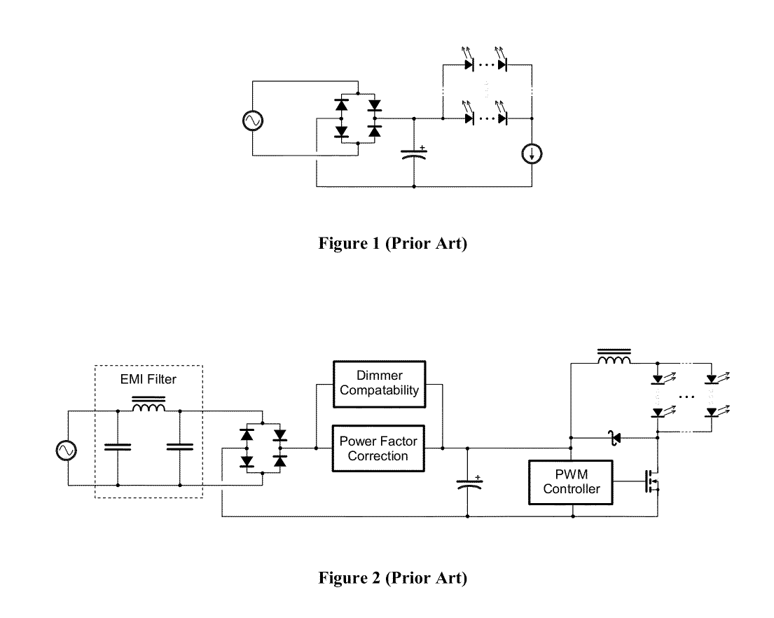

### DETAILED DESCRIPTION OF ILLUSTRATIVE IMPLEMENTATIONS

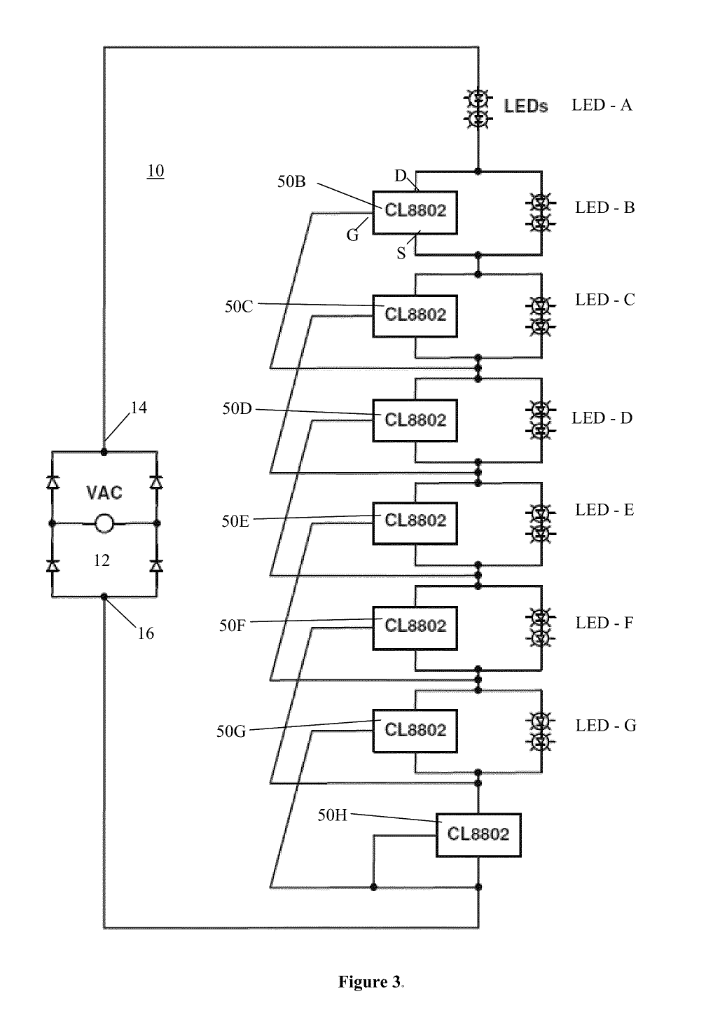

FIG. 3 depicts one example embodiment of one of the inventions disclosed here. For example, an apparatus 10 is shown for regulating power to a string of Light Emitting Diodes (LEDs) LED-B, etc. This apparatus comprises at least two LED groups configured to be connected in parallel, at least two pairs of control units 50B configured to be connected in parallel, and, each control group associated with an LED group LED-B, e.g. In this example the control units each include at least a first terminal D, a second terminal S and a third terminal G and each of the LED groups include a first end and a second end.

Referring again to FIG. 3 there is shown a circuit diagram of one embodiment of the LED driver circuit 10 of the present inventions. The LED driver circuit 10 comprises a bridge rectifier circuit 12 connected to an alternating current (AC) power source. The output of the rectifier circuit 12 is a full wave rectified AC power source having a positive node 14, for supplying a positive voltage, and a negative node 16, acting as a return. As shown in FIG. 3, as an example, a group of LEDs not having an associated control unit, LED-A, six (6) groups of LEDs having an associated control unit, LED-B, LED-C, LED-D, LED-E, LED-F, and LED-G, and a standalone control unit 50H are shown as being serially connected. Clearly, the number of groups of LEDs is arbitrary and is not limited by the present inventions. Each group of LEDs can further comprise a plurality of LEDs which are serially connected or connected in parallel or any combination thereof.

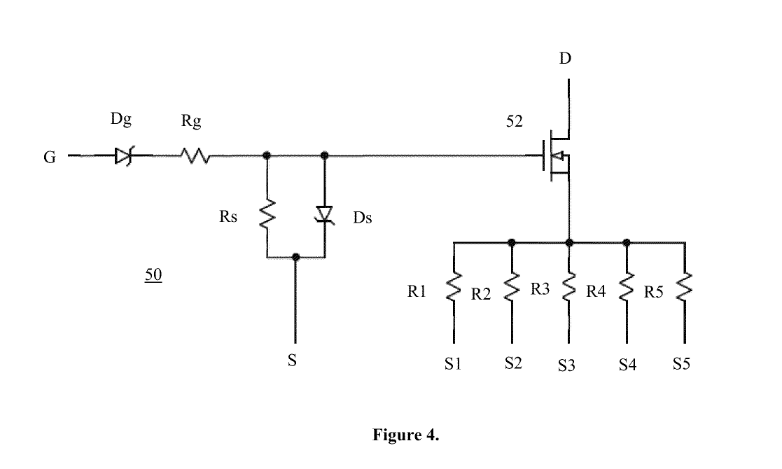

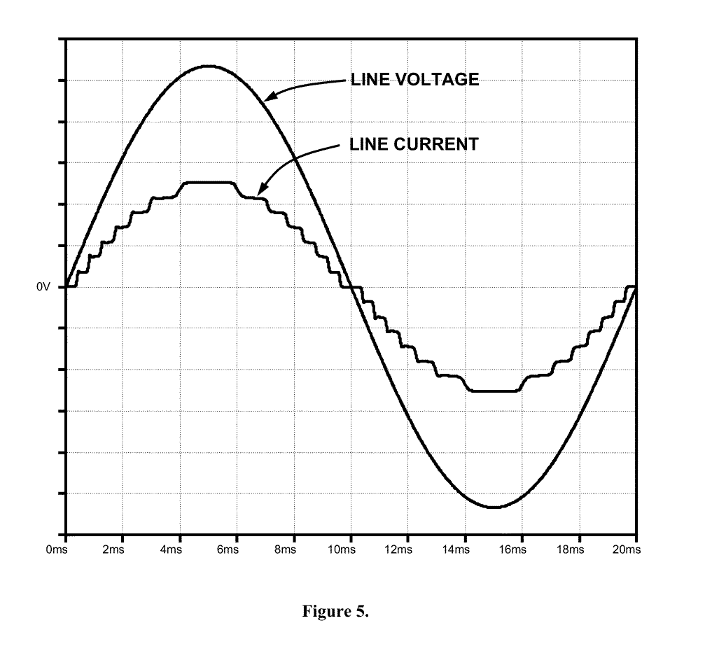

In one example, the control unit 50B, etc. is a MOSFET transistor having a drain terminal D, a source terminal S and a gate terminal G. This is detailed later in FIG. 4.

Except for the first group of LEDs LED-A, each group of LEDs has an associated control unit 50 connected in parallel therewith. Each control unit 50 is a three terminal device, having terminals labeled D, G, and S. The terminals D and S are connected to the ends of the group of the LEDs to which the control unit 50 is associated and to the S and D terminals respectively of the control unit 50 immediately adjacent thereto. Thus, for example, the terminal D of control unit 50C is connected to the terminal S of the control unit 50B, and the terminal D of the control unit 50D is connected to the terminal S of the control unit 50C and etc. The terminal G is connected to the terminal S of an immediately adjacent control unit 50, being the adjacent one closer to the negative node 16. Thus, for example, the terminal G of the control unit 50B is connected to the terminal S of the control unit 50C. The terminal G of the control unit 50C is connected to the terminal S of the control unit 50D, etc. Finally, a control unit 50H, not associated with any group of LEDs is connected in series between the negative node 16 and the end of the last LED group, namely LED-G, with the terminal G of the control unit 50H connected to the terminal S of the control unit 50H.

Still referring to FIG. 3, the example apparatus 10 is configured such that a second end of a first LED group is configured to connect to the first end of an adjacent LED group LED-B. Here, the first terminal D of a first control unit 50B is configured to connect to the first end of the first LED group LED-B. The second terminal S of the first control unit LED-B is configured to be connected to the second end of the first LED group LED-B and the first terminal of an adjacent control unit 50-C. Here, the third terminal G of the first control unit LED-B is configured to be connected to the second end of the adjacent LED group LED-C and the second terminal S of the adjacent control unit 50-C.

Here, for example, the circuit could include at least two pairs of control units and associated LED groups configured to be connected to a stand-alone control unit 50-H, a power source 12 and a stand alone LED group LED-A. The apparatus 10 has a stand-alone LED group LED-A with two ends, a first end and a second end. The first end is configured to be connected to the power source 12, and the second end is configured to be connected to the first end D of the one LED group LED-B and the first terminal of the one control unit 50B.

Further, still referring to FIG. 3, the example apparatus 10 has a stand alone control unit 50H. This has at least a first terminal D, a second terminals and a third terminal G. The first terminal D is configured to connect to the second end of a last LED group, here LED-G, the second terminal S of the last control unit, here 50G, and the third terminal G of the second to last control unit, here 50F. The second terminal S is configured in this stand alone control unit 50H, to be connected to the third terminal G of the stand alone control unit 50H, the third terminal G of the last control unit, here 50G, and a power source 12.

The example power source 12 shown in FIG. 3 has the power source comprises a negative node 16 configured to be connected to the stand alone control unit 50H, a positive node 14 configured to be connected to the stand alone LED group LED-A, and an AC voltage source 12.

Each of the control units 50 (B-H) is shown in greater detail in FIG. 4. Specifically, the control unit 50 comprises a depletion mode MOSFET transistor 52. The depletion mode MOSFET transistor 52 has three terminals Drain, Gate and Source. The Drain terminal of the MOSFET 52 is connected to the D terminal of the control unit 50. The Gate terminal of the MOSFET 52 is connected through a resistor Rg, and through a Zener diode Dg to the terminal G of the control unit 50. The Gate terminal of the MOSFET 52 is also connected through a resistor Rs, which is connected in parallel to a second Zener diode Ds to the terminal S of the control unit 50. Finally, the Source terminal of the MOSFET 52 is connected to a plurality of parallel connected Source Resistors, (R1-R5) to terminals 51 through S5 respectively. Clearly, the number of resistors is not limited to five. In the preferred embodiment, the resistors R1-R5 allow the threshold currents to be programmed by connecting a subset of the resistors to the terminal S. The resistances of resistors R1-R5 are adjusted such that the contribution to the threshold current follows a power of two, that is to say, assuming the connection of R1 to S results in a threshold current I, connecting R2 to S results in a threshold current of 2I, connecting R3 to S results in a threshold current of 4I, etc. Accordingly, threshold current can be adjusted in a steady increment, that is, to one of the values I, 2I, 3I, etc, by appropriate pin strapping. Thus, a single integrated circuit can be manufactured which can be universally applied in a given application as control unit 50 and as ballast unit 50H by virtue of having pin programmable threshold currents. Alternatively a device can be manufactured relying on an external threshold current setting resistor, if more flexibility or a smaller device size is required.

Still referring to FIG. 4, the drain terminal D is connected to the first control unit terminal, the source terminal is in electrical connection with the second control unit terminal and the gate terminal is in electrical connection with the third control unit terminal. The control unit 50 further comprises a resistor, Rg, connected between the gate terminal G and the third control unit terminal, a Zener diode, Dg, connected to the resistor, Rg, and to the third terminal of the control unit.

FIG. 4 shows an example where a resistor, Rs, and a diode, Ds, are connected in parallel to the gate terminal G. The control unit 50 further comprises one or more resistors coupled between the source terminal S of the MOSFET transistor 52 and the second control unit terminal S. In this example, there are 5 resistors, R1-R5.

In FIG. 4's example, the control unit 50 is configured to carrying a bypass current around the LED group associated with the control unit 50, for example LED-B in FIG. 3. The control unit 50 may also be configured to do one or more of the following: act as a short in a region where the bypass current is below a certain threshold level, act as a constant current source in a region where the bypass current is equal to the threshold level, and/or act as open circuit when a sufficiently negative voltage is applied to the third terminal of the control unit.

The threshold current determines at what (drain) current the control unit 50 transitions from being a (near) short to a being a (near ideal) current source.

Each of the control units 50 provides an alternate path for current flow having a much lower voltage drop than otherwise incurred based on the presence of the LED group alone. Thereby, the voltage drop across a plurality of series connected LED groups can be adjusted downward for purpose of promoting current flow at low rectified voltages, and hence across a larger portion of the AC line cycle. The last control unit 50 in the chain, i.e. control unit 50H functions as a ballasting device, similar to a ballast resistor, but having more favorable voltage/current characteristics.

It should be understood that a wide variety of circuits may perform the functions desired of the control unit, whose salient features are as follows: to act as bypass for the LED group current, providing an I-V characteristic which conforms to a low impedance short in a region where the bypass current is less than a preset threshold current, conforms to a constant current source when the bypass current is at the pre-set threshold current while being able to support a voltage as high as the forward voltage of the associated LED group and conforms to an open circuit when a sufficiently negative potential is applied to the third terminal. Implementation of the control unit is not restricted to the use of an N-channel depletion mode MOSFET, but may equally well be attained with an N-channel enhancement mode MOSFET, a NPN type bipolar transistor, an N-channel junction FET, or any of their complementary counterparts, such as a P channel FET or a PNP transistor. Circuitry may also be arbitrarily extended with comparators and amplifiers to provide better control over current threshold or the threshold of the third terminal voltage.

The operation of the control unit 50 and of the device 10 of the present inventions may be understood as follows:

The Gate and Source terminals of the depletion mode MOSFET 52 are effectively shorted through the resistor Rg, thus resulting in zero gate to source voltage. This arrangement is able to carry current of certain maximum amplitude when current is sourced into the Drain terminal. This region of operation corresponds to the I-V characteristic where the device is called upon to act as a short for current below a threshold value. At some current level the MOSFET 52 will resist more current flow and the voltage across the Drain-Source terminals of the MOSFET 52 rises sharply with an incremental rise in drain current. This region of operation corresponds to the I-V characteristics where the device is called upon to act as a current source. The drain current where the transition between short and current source occurs can be lowered by inserting a resistor at the source terminal (one of the source resistors R1-R5) in series with the Source terminal, having the effect of lowering the MOSFET gate to source voltage for any current flow. The control unit 50 allows the threshold current to be set to a range of values by connecting a subset of the source resistors (R1-R5) to the S terminal of the control unit 50. In addition, the flow of drain current can be further reduced or inhibited by applying a negative voltage at the G terminal of the control unit 50. This region of operation corresponds to the I-V characteristics where the device is called upon to act as an open circuit. The Zener diode Ds protects the MOSFET 52 from excessive negative voltage at the Gate. The Zener diode Dg in part sets the threshold voltage required for turning off MOSFET 52 by negative voltage at the Gate.

With respect to the operation of the device 10 shown in FIG. 3, the device 10 operates as follows:

The LED driver device 10 provides power to a plurality of LED groups from a rectified AC power source. Rectified line current originates at the bridge rectifier 12 and flows through a plurality of LED groups, where the rectified line current can flow through the LEDs of an LED group or through an associated control unit 50, or through the combination of both. The control unit 50 is capable of controlling the voltage across the LED group by acting as a low impedance bypass, thereby imposing a low voltage across the LED group, acting as bypass of constant current thereby supporting larger voltages across the LED group, or acting as an open circuit, thereby supporting the full forward voltage of the LEDs of the LED group. The switch from low impedance bypass action to current source action occurs when the rectified line current rises above the threshold current of a control unit 50, and the switch from current source action to open circuit action occurs when the third terminal of a control unit 50 is biased sufficiently negative. The threshold values of the control units 50 associated with the plurality of LED groups are arranged with progressively higher values, causing rectified line current to rise in a step like manner with progressively higher amplitude as the rectified line voltage rises to its peak value, as will be described in greater detail in the following.

For example, the device 10 may be connected to a source of rectified AC voltage. Furthermore, in this example, the source voltage has approximately sinusoidal waveform and that operation starts at the zero crossing of the line voltage. In the following, by way of example, it is assumed that the forward voltage of the LED groups is equal in value, being ⅛th of the peak line voltage. The present inventions are neither restricted to the use of number of LED groups with equal values nor to a particular fraction (n) of the peak voltage. Furthermore, it is assumed, also by way of example and not necessarily for purpose to gain advantageous operation, that the threshold currents of the control units of LED-B, LED-C, LED-C, LED-D, LED-E, LED-F, LED-G and control unit 50H are adjusted to the values I, 2I, 3I, 4I, 5I, 6I, 7I, 8I, where I indicates an arbitrary value and n=8. The higher the n is, the better will be the power factor of the operation.

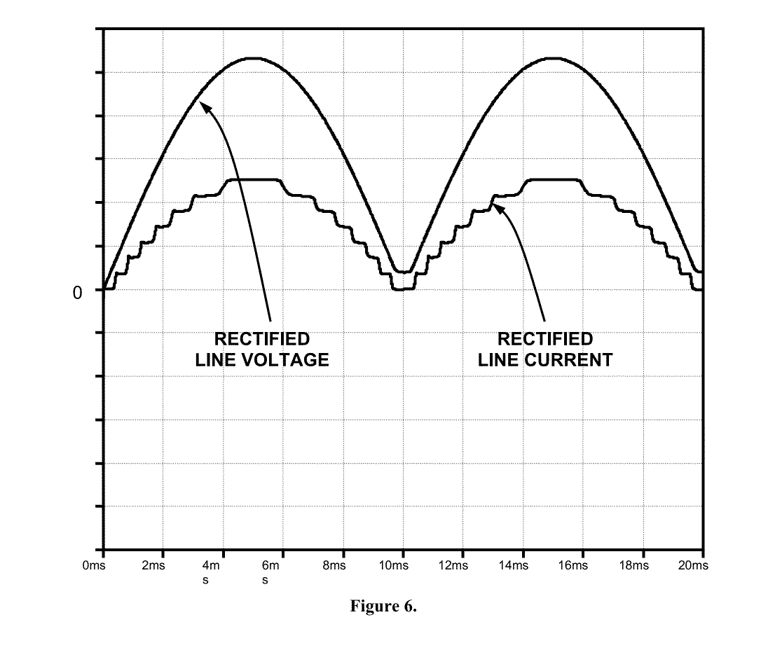

In the region where the rectified voltage rises from zero to ⅛th of the peak line voltage, no rectified line current flows through the device 10 as can be seen in FIG. 6, as it takes a minimum of ⅛th of the peak line voltage to forward bias the first LED group LED-A. Consequently, the line current is zero as well as can be seen in FIG. 5.

In the region where the rectified voltage rises from ⅛th to 2/8th of the peak line voltage, sufficient voltage is available to forward bias group LED-A, and excess rectified line voltage is made to appear across group LED-B and the associated control unit 50B. Rectified line current establishes through the series connection of group LED-A and the control units 50(B-H). As the rectified line voltage rises above ⅛th of peak line voltage, flow of rectified line current encounters small incremental impedance from the group LED-A and the control units 50(B-H), which behave like shorts. Consequently, the rectified line current rises rapidly at the start of the region until reaching the current value I where control unit 50B changes from behaving like a short to behaving like a constant current source, thereby stabilizing the rectified current at the threshold value I. The change from low to high incremental impedance causes the remaining rise of the rectified line voltage to appear across the control unit 50B and its associated group LED-B. At the end of the region, group LED-B is on the verge of conduction as the voltage across group B approaches the forward voltage of the LED group.

In the region where the rectified voltage rises from 2/8th to ⅜th of the peak line voltage, sufficient voltage is available to forward bias group LED-A and LED-B, and excess rectified line voltage is made to appear across group LED-C and the associated control unit 50C. Rectified line current establishes through the series connection of group LED-A and LED-B and the control units 50(B-H). As the rectified line voltage rise above 2/8th of peak line voltage, flow of rectified line current encounters small incremental impedance from the group LED-A and LED-B and the control units 50(C-H), which behave like shorts. Consequently, the rectified line current rises rapidly at the start of the region until reaching the current value 2I where control unit 50C changes from behaving like a short to behaving like a constant current source, thereby stabilizing the rectified current at the threshold value 2I. The change from low to high incremental impedance causes the remaining rise of the rectified line voltage to appear across the control unit 50C and its associated group LED-C. At the end of the region, group LED-C is on the verge of conduction as the voltage across group C approaches the forward voltage of the LED group.

Furthermore, at some point during the rise of the voltage across group LED-C, the control unit 50B of LED-B changes from behaving like a constant current source to behaving like an open circuit by the fact that the third terminal of the control unit 50B is being biased negative by the voltage appearing across group LED-C. This action transfers the current flow I from the control unit 50B to the associated LEDs of group LED-B, thereby getting full use of the rectified line current for the production of light in LED-B. The transfer action preferably occurs early on in the region where the voltage rises across the LED group LED-C, which can be attained by judicious choice of the Zener voltage of Zener diode Zg, the resistors Rg and Rs, and the pinch off voltage of the MOSFET device 52.

In the region where the rectified voltage rises from ⅜th to 4/8th of the peak line voltage, sufficient voltage is available to forward bias groups LED-A, LED-B and LED-C, and excess rectified line voltage is made to appear across group LED-D and the associated control unit 50D. Rectified line current establishes through the series connection of group LED-A, LED-B and LED-C, and the control units 50(C-H). As the rectified line voltage rise above ⅜th of peak line voltage, flow of rectified line current encounters small incremental impedance from the groups LED-A, LED-B and LED-C and the control units 50(D-H), which behave like shorts. Consequently, the rectified line current rises rapidly at the start of the region until reaching the current value 3I where control unit 50D changes from behaving like a short to behaving like a constant current source, thereby stabilizing the rectified current at the threshold value 3I. The change from low to high incremental impedance causes the remaining rise of the rectified line voltage to appear across the control unit 50D and its associated group LED-D. At the end of the region, group LED-D is on the verge of conduction as the voltage across group LED-D approaches the forward voltage of the LED group.

Furthermore, at some point during the rise of the voltage across group LED-D, the control unit 50C of LED-C changes behavior from behaving like a constant current source to behaving like an open circuit by the fact that the third terminal of the control unit 50C is being pulled negative by the voltage appearing across group LED-D. This action transfers the current flow 2I from the control unit 50C to the associated LEDs of group LED-C, thereby getting full use of the rectified line current for the production of light in LED-C.

The process as described for the region where the voltage rises from ⅜th to 4/8th of the peak line voltage repeats mutatis mutandis as the rectified line voltage traverses a subsequent region of voltage spanning the forward voltage of the next LED group in line and at a higher current corresponding to the threshold of the next control unit in line. As the rectified line voltage rises in increments of ⅛th of the peak line voltage, the rectified line current rises in increments of the current value I. Line current draw follows line voltage in shape in a step like manner, preserving the sinusoidal nature of the voltage to a large degree, thus resulting in high power factor operation.

Depending on design or operating environment, the rectified line voltage may exceed the forward voltage of all in series connected LED groups combined. Exceeding the maximum forward voltage of all in series connected LED groups would result in a rapidly increasing current through the LEDs without bound if it were not for the presence of the last control unit 50H. Control unit 50H will act as a current source with a threshold current of 8I having high incremental impedance should the rectified line current reach the value 8I, thereby setting a maximum to the rectified line current of the device 10. Any further rise in source voltage can not cause a further rise in LED current, as there is no LED group in parallel for additional current to divert to, and just leads to higher voltage across this control unit, thereby taking on the function not unlike the ballast resistor.

The behavior of the device 10 plays in reverse as the rectified voltage starts to drop, as can be seen from the waveforms of line voltage and line current depicted in FIG. 5, and the waveforms of rectified line voltage and rectified line current depicted in FIG. 6.

Finally, it should be clear that the control unit 50 can be made from discrete components or from an integrated circuit, or a combination thereof. For example, an alternate arrangement can be manufactured where the threshold current is programmed by a single source resistor located external to the integrated circuit instead of the internal programming resistors R1 thru R5.

1. An apparatus for regulating power to a string of Light Emitting Diodes (LEDs) comprising:
at least two LED groups configured to be connected in parallel;
at least two pairs of control units configured to be connected in parallel, each control group associated with an LED group;
wherein the control units each include at least a first terminal, a second terminal and a third terminal; and
wherein each of the LED groups include a first end and a second end.

2. The apparatus of claim 1 wherein the second end of a first LED group is configured to connect to the first end of an adjacent LED group;
wherein the first terminal of a first control unit is configured to connect to the first end of the first LED group;
wherein the second terminal of the first control unit is configured to be connected to the second end of the first LED group and the first terminal of an adjacent control unit;
wherein the third terminal of the first control unit is configured to be connected to the second end of the adjacent LED group and the second terminal of the adjacent control unit.

3. The apparatus of claim 2 further comprising:
a circuit including the at least two pairs of control units and associated LED groups configured to be connected to a stand-alone control unit, a power source and a stand alone LED group.

4. The apparatus of claim 3 wherein the stand-alone LED group has two ends, a first end and a second end, wherein the first end is configured to be connected to the power source, and wherein the second end is configured to be connected to the first end of the one LED group and the first terminal of the one control unit.

5. The apparatus of claim 3 wherein the stand alone control unit has at least a first terminal, a second terminal and a third terminal;
the first terminal configured to connect to the second end of a last LED group, the second terminal of the last control unit and the third terminal of the second to last control unit;
the second terminal configured to be connected to the third terminal of the stand alone control unit, the third terminal of the last control unit and a power source.

6. The apparatus of claim 3 wherein the power source comprises:
a negative node configured to be connected to the stand alone control unit;
a positive node configured to be connected to the stand alone LED group; and
an AC voltage source.

7. The apparatus of claim 1 wherein the control unit further comprises:
a MOSFET transistor having a drain terminal, a source terminal and a gate terminal.

8. The apparatus of claim 7 wherein the drain terminal is connected to the first control unit terminal, the source terminal is in electrical connection with the second control unit terminal and the gate terminal is in electrical connection with the third control unit terminal.

9. The apparatus of claim 8 wherein the control unit further comprises:
a resistor, Rg, connected between the gate terminal and the third control unit terminal;
a Zener diode, Dg, connected to the resistor, Rg, and to the third terminal of the control unit.

10. The apparatus of claim 9 further comprising a resistor, Rs, and a diode, Ds, connected in parallel to the gate terminal.

11. The apparatus of claim 8 wherein the control unit further comprises one or more resistors coupled between the source terminal of the MOSFET transistor and the second control unit terminal.

12. The apparatus of claim 11 consisting of 5 resistors.

13. The apparatus of claim 1 wherein the LED groups comprise at least two of LEDs in series.

14. The apparatus of claim 1, wherein the control unit is configured to carrying a bypass current around the LED group associated with the control unit.

15. The apparatus of claim 1 wherein the control unit is configured to one or more of:
act as a short in a region where the bypass current is below a certain threshold level, act as a constant current source in a region where the bypass current is equal to the threshold level, and/or act as open circuit when a sufficiently negative voltage is applied to the third terminal of the control unit.

16. A method of regulating power to a string of Light Emitting Diodes (LEDs), the method comprising:
controlling power to the string of LEDs via 2 or more control units connected in parallel with 2 or more associated LED groups;
configuring a control unit to act as a short in a region where the bypass current is below a certain threshold level;
configuring the control unit to act as a constant current source in a region where the bypass current is equal to the threshold level; and/or
configuring the control unit to act as open circuit when a sufficiently negative voltage is applied to the third terminal of the control unit.

17. A method of regulating power to a string of Light Emitting Diodes (LEDs) comprising:
receiving a signal at a first terminal of a control unit configured to be connected in parallel with an LED group;
sending a signal from a second terminal in the control unit; and
sending a signal from a third terminal in the control unit;
wherein the control unit and LED group is configured to be connected with an adjacent control unit and LED group in parallel.

18. The method of claim 17 further comprising configuring a control unit to act as a short in a region where the bypass current is below a certain threshold level.

19. The method of claim 17 further comprising configuring the control unit to act as a constant current source in a region where the bypass current is equal to the threshold level.

20. The method of claim 17 further comprising configuring the control unit to act as open circuit when a sufficiently negative voltage is applied to the third terminal of the control unit.

21.-26. (canceled)
